(19) United States
(12) Patent Application Publication
(10) Pub. No.: US 2026/0242264 A1
(43) Pub. Date: Aug. 20, 2026

(54) ONSITE SUSTAINABLE SANITATION DEVICES FOR WATER AND NUTRIENT RECYCLING AND METHODS OF USE THEREOF

(71) Applicant: University of Florida Research Foundation, Inc., Gainesville, FL (US)

(72) Inventors: Heidimarie Wittmann, Gainesville, FL (US); Nawari O. Nawari, Gainesville, FL (US); Michael Volk, Gainesville, FL (US)

(21) Appl. No.: 18/992,661

(22) PCT Filed: Jul. 28, 2023
(86) PCT No.: PCT/US2023/071166

§ 371 Date: Jan. 9, 2025

Related U.S. Application Data
(60) Provisional application No. 63/369,886, filed on Jul. 29, 2022.

(51) Int. Cl. C02F 9/00; C02F 1/28; C02F 1/32; C02F 1/44; C02F 3/08; C02F 3/32; C02F 103/00; C02F 103/32

(52) U.S. Cl. CPC C02F 9/00; C02F 1/283; C02F 1/32; C02F 1/444; C02F 3/082; C02F 3/322; C02F 2103/005; C02F 2103/32; C02F 2303/04

(57) ABSTRACT

Disclosed are various systems, comprising a macerating pump having a solid waste input and configured to convert the waste into a slurry. The system includes a holding tank in fluidic communication with the pump. The system includes a bioreactor in fluidic communication with the holding tank and configured to biochemically break down the slurry into gas(es) and a liquid substrate. Additionally, the system has a biochar filter in fluidic communication with the bioreactor and configured to absorb nutrients from the liquid substrate to produce a treated liquid substrate. The system includes a sterilization unit after the biochar filter, where the sterilization unit is configured to remove a plurality of pollutants from the treated liquid substrate.

### CROSS-REFERENCE TO RELATED APPLICATION

This application claims priority to co-pending U.S. provisional application entitled “Onsite Sustainable Sanitation Devices for Water and Nutrient Recycling and Method of Use Thereof” having Ser. No. 63/369,886, filed on Jul. 29, 2022, which is entirely incorporated herein by reference.

### BACKGROUND

The sustainability of sanitation, energy, health, agriculture, and sociocultural economics are highly dependent upon one another. Sanitation is critical to ecological and human health, and yet continues to be nearly ignored. Only 2% of activities towards achieving Sustainable Development Goals have been linked with sanitation. Only 3% focus on wastewater treatment.

For typical wastewater treatment, bathrooms represent a large amount of embodied energy: methane emissions are the greatest part of the carbon footprint; water reuse greatly decreases eutrophication potential; and energy recovery reduces the carbon footprint.

### BRIEF DESCRIPTION OF DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a diagram of an example process for water and nutrient recycling according to various embodiments of the present disclosure.

FIG. 2 is a flowchart depicting an example process for water and nutrient recycling according to various embodiments of the present disclosure.

FIG. 3 is a flowchart depicting an example process for water and nutrient recycling according to various embodiments of the present disclosure.

FIG. 4 is a flowchart depicting an example process for water and nutrient recycling according to various embodiments of the present disclosure.

FIG. 5 is a flowchart depicting an example process for water and nutrient recycling according to various embodiments of the present disclosure.

### DETAILED DESCRIPTION

Current centralized wastewater treatment practices rely heavily on treated, drinkable water to carry waste. They also rely heavily on massive investments of energy and capital, and yet commonly fail and cause pollution when challenged. There is an acute need for greater resilience of systems—of water and energy, and nutrient management to prevent both eutrophication and soil depletion.

Residential and small commercial decentralized units still rely heavily on septic system technology, despite its challenges and the availability of other options. Septic systems use large amounts of drinking-quality water and treat water and nutrients as a waste product. Onsite septic system technology has a 10-20% lifetime failure rate according to code definition and is a major contributor to water pollution. The rate of polluting systems not deemed failing may be much higher, due to the lack of tracing. Septic systems are not suitable for all decentralized wastewater treatment applications. In fact, approximately two-thirds of all land area in the United States is estimated to be unsuitable for the installation of septic systems.

Ecological or sustainable sanitation can have a significant impact on water and pollution crises and decrease stress on the water-energy nexus. Many nature-based, decentralized technologies exist, and have been successfully implemented globally. Regenerative or ecological sanitation could increase resilience on a small (household) scale, reduce pollution, and lead to reduced investment in accessing clean water resources. Nutrients that are recaptured can be utilized in agriculture, leading to soil improvement, increased food security, and decreased pollution, increasing quality of life. Systems with high recovery rates include onsite composting and blackwater systems. A gap exists in practice and data regarding decentralized sustainable sanitation. Additional improved options need to be developed.

The present disclosure provides for ecological or nature-based sanitation aspects that can mitigate the current crises of water shortages and pollution and provide a more sustainable alternative to septic technology. Aspects of the present disclosure provide for technologies that can be combined, are modular, scalable, meet or exceed treatment standards, and/or reclaim water and nutrients.

Aspects of the present disclosure can be broadly described by the following: the assembly receives toilet flush water, known as “blackwater,” which is conveyed through a grinder pump and into an aboveground vessel. The vessel is a type of bioreactor that conducts thermophilic aerobic digestion. The vessel contains an aerator to enable aerobic digestion, and may or may not require a mixer. A biological digestion process occurs that generates enough heat to sterilize the mixture. After the slurry has reached desired temperature (within 4-12 hours depending on conditions), heat can be recovered, and the slurry discharged through the biochar filtration module. The biochar module captures nutrients from the slurry and removes a high percentage of the few remaining bacteria as it trickles through the material, and water is released into the sterilization chamber. In an aspect, the UV sterilization can optionally occur immediately prior to flushing to discourage post treatment bacterial growth and optionally can occur immediately adjacent to the toilet tank. One or more combinations of these technologies should meet or exceed toilet water reuse standards, enabling near-perpetual reuse of the same volume of water. In an aspect, the biochar should be removed periodically to agricultural land as a soil amendment.

In the following discussion, a general description of aspects of various systems and methods and its components is provided, followed by a discussion of the operation of the systems. Although the following discussion provides illustrative examples of the operation of various components of the present disclosure, the use of the following illustrative examples does not exclude other implementations that are consistent with the principles disclosed by the following illustrative examples.

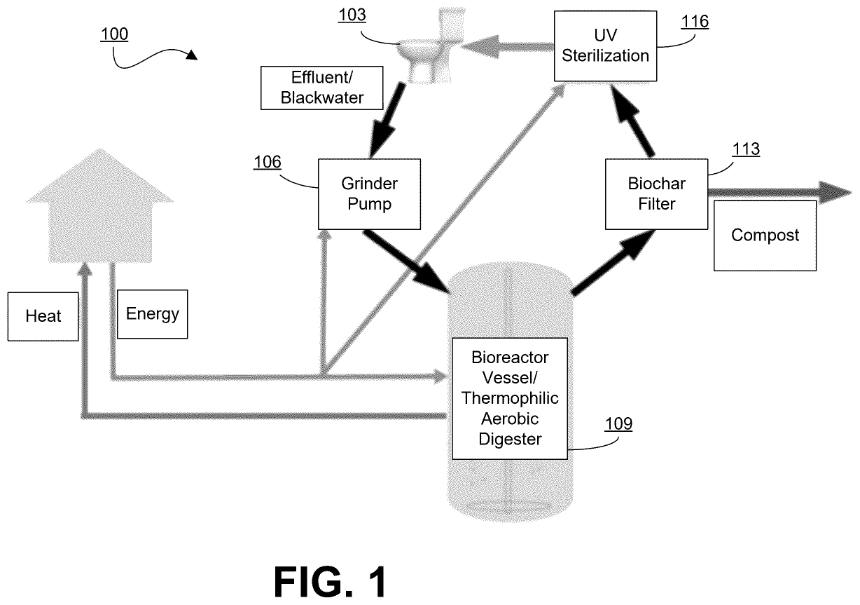

With reference to FIG. 1, shown is an example of a wastewater recycling system 100 for onsite sanitation of residential blackwater. The wastewater recycling system 100 can include a toilet 103, a grinding pump 106, a bioreactor 109, a filter 113, and a sanitation unit 116, as well as numerous other components. In some embodiments, the wastewater recycling system 100 includes one or more holding tanks 119 disposed at various steps in the process. The wastewater recycling system 100 uses blackwater from residential toilets 103 and, optionally, food waste as well. The wastewater recycling system 100 is configured to treat blackwater and food waste to decrease pollution, recycle treated water back to a toilet, and recover nutrients. In some embodiments, the wastewater recycling system 100 is located onsite at a residential, multi-family, or commercial property to perform these functions. In some embodiments, the wastewater recycling system 100 is located nearby, or adjacent to a residential, multi-family, or commercial property to perform these functions.

The wastewater recycling system 100 begins and, in some embodiments, ends with the toilet 103. The toilet 103 functions to convey solid waste and blackwater to the other components of the wastewater recycling system 100. In some embodiments, the toilet 103 is a standard flush toilet and uses pressure and gravity to covey waste to the wastewater recycling system 100. In some embodiments, the toilet 103 is a vacuum toilet which uses suction and a small amount of water to convey waste to the wastewater recycling system 100.

In some embodiments, the toilet 103 includes a grinding pump 106 to break down the solid waste and mix it with the water to create a slurry. In some embodiments, the grinding pump 106 is located downstream of the toilet 103 in the wastewater recycling system 100 and is in fluidic communication with the toilet 103. The grinding pump 106 can be a macerator pump typically found in toilets 103. In some embodiments, the grinding/macerating element is combined with a pump to form a grinding pump 106. In some embodiments, the grinding/macerating feature is separated from the pump.

In some embodiments, the wastewater recycling system 100 further comprises a receiving system 123. In some embodiments, the receiving system 123 is part of a kitchen garbage disposal. In some embodiments, the receiving system 123 comprises a receptacle for food waste. In some embodiments, the receiving system 123 is connected to, or in fluidic communication with, a holding tank 119 such that food waste enters the holding tank 119 through the receiving system 123. The receiving system 123 can be a pipe, tube, trough, receptacle, or inlet in the holding tank 119. The receiving system 123 can include an additional grinding pump 106 to grind and mix the food waste.

In some embodiments, the wastewater recycling system 100 contains a holding tank 119. The holding tank 119 can be a container with one or more inlets or outlets, where the container can be made of materials such as metal, plastic, etc., and be of sufficient volume (e.g., 10 L to 100 L or more), which may vary based on the setting (e.g., single house, duplex, apartment building, and the like). The holding tank 119 is disposed between the grinding pump(s) 106 and the treatment components of the wastewater recycling system 100 (e.g., the bioreactor 109, the filter 113, the sanitation unit 116, and various other components as well). In some embodiments, the holding tank 119 is in fluidic communication the grinding pump(s) 106 as well as one or more of the downstream treatment components (e.g., the bioreactor 109, the filter 113, the sanitation unit 116, and various other components as well). The holding tank 119 is configured to receive the slurry from the waste sources (e.g., toilet(s) 103, receiving system(s) 123, etc.), hold the slurry, and transport the slurry to the remaining components of the wastewater recycling system 100. In some embodiments, the holding tank 119 has an outlet which can be configured to regulate and control the rate and timing of the processing, if needed. The outlet of the holding tank 119 can be a nozzle, a pump, a drain, a faucet or other suitable means to control the flow of the slurry out of the holding tank 119. In some embodiments, the holding tank 119 includes a vent for gases, an overflow prevention feature, an emergency bypass to allow overflow to a sewer, an emergency lockdown mechanism to seal the tank for safety in the case of flooding, and/or other safety features to prevent physical damage, environmental harm, or other hazardous conditions.

The wastewater recycling system 100 further includes a bioreactor 109. The bioreactor 109 receives the slurry and uses biological and/or biochemical reactions to break down the slurry into gases and a liquid substrate. In some embodiments, the bioreactor 109 is in fluidic communication with the grinding pump 106 and receives the slurry from the grinding pump 106. In some embodiments, the bioreactor 109 is in fluidic communication with the holding tank 119 and receives the slurry from the holding tank 119. The bioreactor 109 includes an inlet, through which the bioreactor 109 receives the slurry; a reaction vessel or tank, where the biological and/or biochemical reactions take place; an outlet for the release of gases; and an outlet for the treated liquid substrate. The reaction vessel can be a container with one or more inlets or outlets, where the container can be made of materials such as metal, plastic, etc., and be of sufficient volume (e.g., 10 L to 100 L or more), which may vary based on the setting (e.g., single house, duplex, apartment building, and the like). Optionally, the bioreactor 109 includes a flow regulator or doser at the inlet to control the rate of flow to the reaction vessel. Optionally, the bioreactor 109 includes a flow regulator or doser at the outlet to control the rate of flow out of the reaction vessel. According to various examples, the bioreactor 109 includes an outlet for gases as well as the outlet for the treated liquid substrate. In some embodiments, the gas outlet from the bioreactor 109 includes a gas filter. The gas filter can be an algae biofilter, a microalgae biofilter, a biochar filter, or other gas filter. As an algae or microalgae filter, the gas filter can include a containment vessel, which is transparent to allow for light to enter the vessel. The algae can use photosynthesis to metabolize carbon dioxide, nitrogen, phosphorous, and other nutrients.

The bioreactor 109 can additionally include a rotational mechanism to mix and aerate the slurry to encourage the breakdown of the components. In some embodiments, the rotational mechanism is an impeller, an agitator, a plurality of rotating discs, a rotating drum with a plurality of baffles, or another kind of rotating mechanism capable of mixing and aerating the slurry. In some embodiments, the rotational mechanism includes one or more attached biofilms to assist in the treatment of the slurry. In some embodiments, the bioreactor 109 includes a control system which includes a power system and a plurality of sensors. The power system can be a solar power system, a battery power system, a wind power system, a water power system, or another form of power system capable of powering the controls, electrical, and mechanical systems of the bioreactor 109. The plurality of sensors can include pH sensors, oxygen sensors, thermometers, turbidity sensors, or other sensors configured to monitor the conditions inside the bioreactor 109. The plurality of sensors can record and/or transmit data to the control system. In some embodiments, the bioreactor 109 includes a heating and/or cooling system. The heating and/or cooling system can be used to increase or decrease the temperature of the slurry inside the bioreactor 109 to facilitate the breakdown of different components. In some embodiments, the bioreactor 109 includes a heat exchanger to harvest heat produced by the reactions in the reaction vessel. The heat captured by the heat exchanger can be converted to energy to be used as power for the bioreactor 109, to be stored as an accessible energy source, and/or to be used as heat or energy for the residence or multi-family or commercial property.

In some embodiments, the bioreactor 109 is an aerobic digester, a rotating biological contactor (RBC), or a vermicomposting vessel. As an aerobic digester, the bioreactor 109 can include an augmentation system, i.e., a mechanized system for dosing microorganism and/or enzyme additives. In some embodiments, the augmentation system controls the addition of algae, bacteria, enzymes, chemicals, or other additives to control the reactions and environment of the reaction vessel. As an RBC, the bioreactor 109 includes attachments on the rotating mechanism to support the growth of biofilms which contribute to the break down reactions. The RBC can include several horizontal shafts of rotating discs with lattice-structured medium submerged in the liquid substrate and slurry in the reaction vessel. Rotating the structures alternately expose the biofilm-occupied medium to the wastewater and to gases such as carbon dioxide and oxygen, to encourage aerobic degradation of organic matter. Additionally, rotation creates a mechanical mixing action, keeping organic matter in suspension, and allowing sloughing of excess biofilm mass. The RBC bioreactor 109 can also include an augmentation system for dosing microorganism and/or enzyme additives. In some embodiments, the augmentation system controls the addition of algae, bacteria, enzymes, chemicals, or other additives to control the reactions and environment of the reaction vessel. As a vermicomposting vessel, the bioreactor 109 includes a substrate within the reaction vessel. The substrate is a bio-base fibrous material (e.g., wood chips, or other similar material), which serves as a habitat for the worms. The substrate additionally provides gaps through which gases can flow, leachate can drain, and the worms can travel. The bioreactor 109 can include separate outlets for the leachate from vermicomposting and for the biomass left over from vermicomposting.

Additionally, the wastewater recycling system 100 includes a filter 113. The filter 113 is in fluidic communication with the bioreactor 109. The filter 113 serves to remove pollutants such as heavy metals, organic matter, nitrogen, phosphorous, E. coli and other pathogenic bacteria, or other contaminants. The filter 113 can include sensors and a control system to monitor and regulate the processes occurring within the filter 113. Additionally, the filter 113 includes an outlet for treated water. As a biochar filter, the filter 113 includes an outlet for biomass, where the biomass can be removed via the outlet. According to various examples, the biomass from the biochar filter 113 can be removed as loose material, or in a cartridge format where the biochar is contained in a vessel and replaced with a new vessel containing biochar at an appropriate time interval. In some embodiments, the biomass can be used as a soil amendment in agricultural land. In some embodiments, the wastewater recycling system 100 includes multiple filters of the same or different types.

In some embodiments, the wastewater recycling system 100 includes a second holding tank 119 in fluidic communication with, and disposed between, the filter 113 and the sanitation unit 116. The second holding tank 119 can be configured similar to the first holding tank 119. The second holding tank 119 can be a container with one or more inlets or outlets, where the container can be made of materials such as plastic, metal, etc., and be of sufficient volume (e.g., 10 L to 100 L or more), which may vary based on the setting (e.g., single house, duplex, apartment building, and the like). The second holding tank 119 includes an inlet for treated water from the filter 113 as well as an outlet to the sanitation unit 116. The inlet and outlet can be controlled to regulate the flow in and out of the holding tank 119.

The sanitation unit 116 can be in fluidic communication with the filter 113, the holding tank 119, and/or the toilet 103. In some embodiments, the sanitation unit 116 is an ultraviolet (UV) sterilization unit. The UV sterilization unit uses UV light to kill bacteria that may be in the treated water after filtration. The UV sterilization unit can include a device to produce UV light such as a UV LED. In some embodiments, the sanitation unit 116 is a microfilter. Microfiltration through a membrane in the sanitation unit 116 can eliminate bacteria and particles that were not filtered out with the filter 113. In some embodiments, the sanitation unit 116 is an ultrafilter. Ultrafiltration through a membrane in the sanitation unit 116 can remove bacteria and particles from the treated water as well. In some embodiments, the sanitation unit 116 can use a combination of UV sterilization and secondary filtration (micro- and/or ultra-) to sterilize the treated water. After the water has been treated in the sanitation unit 116, it can be returned to the toilet 103.

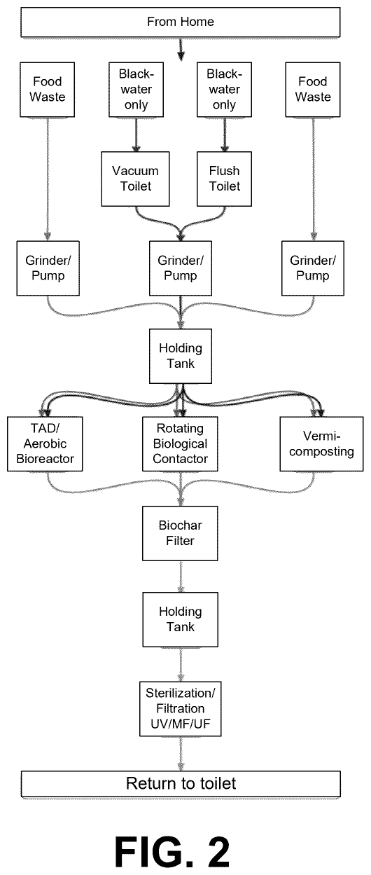

Moving to FIG. 2, shown is an example flowchart of the process of the wastewater recycling system 100. In this example, the process begins with receiving blackwater and/or food waste from a home. The blackwater is received through either a vacuum toilet 103, a flush toilet 103, or both. The blackwater and/or the food waste are processed in a grinding pump 106, or macerator pump, to produce a slurry. Optionally, the slurry is held in a holding tank 119 to enable the regulation of the rate of processing. The slurry then flows to a bioreactor 109. While shown in parallel, the TAD/Aerobic Bioreactor, Rotating Biological Contactor, and Vermicomposting blocks are each different forms of bioreactors 109. The wastewater recycling system 100 can use one or more of these types of bioreactors 109 to process the slurry and decompose it into liquid substrate, gases, biomass, and nutrients. Next, the liquid substrate can be collected from the bioreactor 109 and can flow through a filter 113. Shown in FIG. 2 is a biochar filter; however, the filter 113 could, in some embodiments, be another type of filter. In some embodiments, the liquid substrate is filtered through a biochar filter and another filter. Optionally, the treated water exiting the filter(s) 113 is collected in a second holding tank 119. The treated water can be directed from the second holding tank 119, or directly from the filter 113, to the sanitation unit 116. As discussed above, the sanitation unit 116 can include a combination of sanitation, sterilization, and/or filtration steps to complete the treatment of the water. Once the water has undergone treatment in the sanitation unit 116, the water can be returned back to the toilet 103 to be reused.

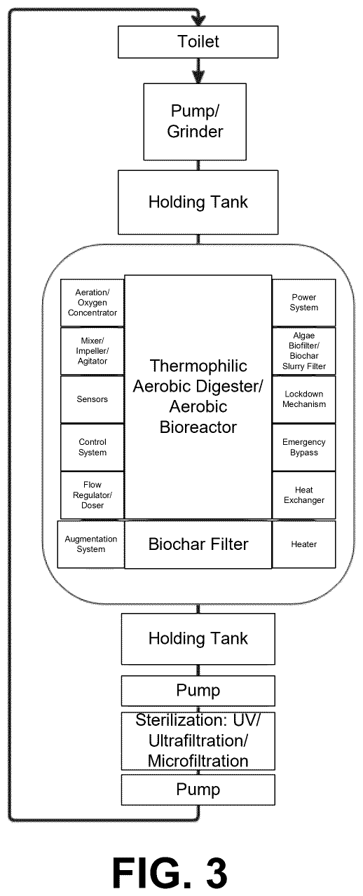

Next, FIG. 3 shows an example flowchart of the process of the wastewater recycling system 100. In this example, effluent (blackwater) is mechanically processed to a uniform slurry and conveyed to the bioreactor tank. A biological process that is either self-initiated or artificially initiated begins breaking down the organic matter contained in the effluent. The effluent is aerated/oxygenated to encourage the activity of thermophilic bacteria. As a result of their metabolic action, the slurry is sterilized (or nearly sterilized) due to the increase of temperature up to 70 degrees Celsius, and stabilized. In this state, it can be immediately used for land application as fertilizer. In this assembly, the mixture is passed through a biochar filter which absorbs the nutrients and is stored for later removal for land application. Any water which has not been absorbed has been processed twice at this stage and should be close to toilet water standards. A final sterilization or filtration (including sterilization) step will occur immediately prior to reuse to ensure sterility of the reused water. The water can then be immediately recirculated to the flush tank of the toilet.

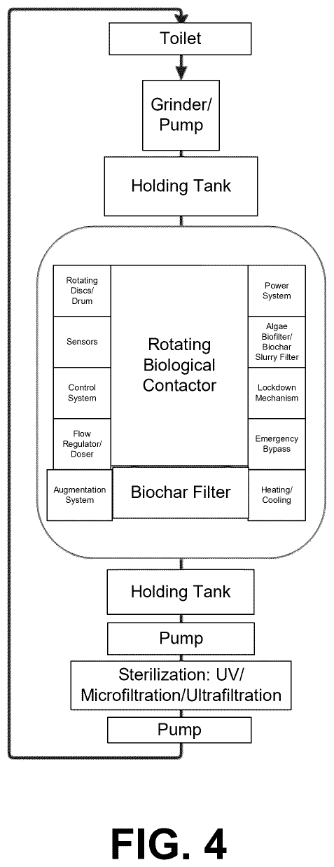

In FIG. 4, shown is an example flowchart of the process of the wastewater recycling system 100. In this example, effluent (blackwater) is mechanically processed to a uniform slurry and conveyed to the rotating biological contactor. The slurry is processed by bacteria or an algae-bacteria combination contained in biofilm which is attached to surfaces inside the tank. The biofilm can attach to either a series of discs which rotate through the effluent/slurry, or structures attached to the walls of a rotating tank. The purpose of rotation is to expose the biofilm both to the nutrient-dense solution as well as air (mechanical aeration) and light to feed their metabolic reactions which break down the organic matter in the solution. The nutrients from the organic matter are absorbed by the organisms in the biofilm, which grows in mass and eventually sloughs off to be digested and processed with the effluent. The remaining effluent is passed through a biochar filter that absorbs the nutrients and is stored for later removal for land application. Any water which has not been absorbed has been processed twice at this stage and should be close to toilet water standards. A final sterilization or filtration (including sterilization) step will occur immediately prior to reuse to ensure sterility of the reused water. The water can then be immediately recirculated to the flush tank of the toilet.

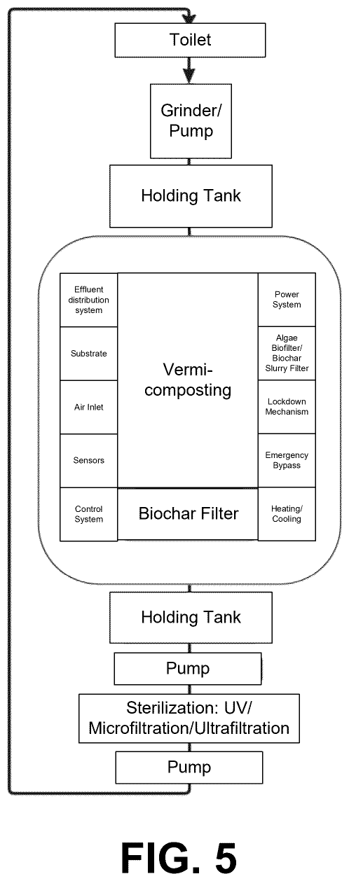

Moving to FIG. 5, shown is an example flowchart of the process of the wastewater recycling system 100. In this example, vermicomposting or vermifiltration involves the physical breakdown of organic matter by select earthworm species, as well as biochemical processes that happen within their digestive tracts. This process is used extensively for the processing of food waste, and can also be applied to wastewater and blackwater. The byproduct of their activity is called worm castings, and is desired as a fertilizer product. Vermicomposting assemblies include a containment unit and organic substrate such as wood chips. The remaining effluent is passed through a biochar filter which absorbs the nutrients and is stored for later removal for land application. Any water which has not been absorbed has been processed twice at this stage and should be close to toilet water standards. A final sterilization or filtration (including sterilization) step will occur immediately prior to reuse to ensure sterility of the reused water. The water can then be immediately recirculated to the flush tank of the toilet.

Aspects of the present disclosure are described further in the Examples below.

### Example 1

Onsite septic system technology is one major contributor to water pollution. Like centralized wastewater treatment, septic systems use large amounts of drinking-quality water and treat water and nutrients as a waste product. Established technology can treat blackwater onsite while recycling water and sparing nutrients which can decrease pollution to nearly zero and increase agricultural crop yields. This disclosure proposes prototypes based on sustainability criteria and compared to current water reuse standards. The analysis of the prototypes showed promise in enabling onsite recycling of blackwater to toilet water flushing while reclaiming nutrients.

### INTRODUCTION

Sanitation, energy, health, agriculture, and sociocultural economics are highly linked. Their sustainability depends on one another. Sanitation is critical to ecological and human health, and yet continues to be nearly ignored. Only 2% of activities towards achieving Sustainable Development Goals have been linked with sanitation. Only 3% focus on wastewater treatment.

For typical wastewater treatment, bathrooms represent a large amount of embodied energy, methane emissions are the greatest part of the carbon footprint, water reuse greatly decreases eutrophication potential, and energy recovery reduces the carbon footprint.

Current centralized wastewater treatment practices rely heavily on treated, drinkable water to carry waste. They also rely heavily on massive investments of energy and capital, and yet commonly fail and cause pollution when challenged. There is an acute need for greater resilience of systems—of water and energy, and nutrient management to prevent both eutrophication and soil depletion.

Residential and small commercial decentralized units still rely heavily on septic system technology, despite its challenges and availability of other options. Septic systems use large amounts of drinking-quality water and treat water and nutrients as a waste product. Onsite septic system technology has a 10-20% lifetime failure rate according to code definition (EPA, 2002) and is a major contributor to water pollution (EPA, 2017). The rate of polluting systems not deemed failing may be much higher, due to the lack of tracing. Septic systems are not suitable for all decentralized wastewater treatment applications. In fact, approximately two-thirds of all land area in the United States is estimated to be unsuitable for the installation of septic systems (EPA, 2000).

Ecological or sustainable sanitation can have a significant impact on water and pollution crises and decrease stress on the water-energy nexus. Many nature based, decentralized technologies exist, and have been successfully implemented globally. Regenerative or ecological sanitation could increase resilience on a small (household) scale, reduce pollution, and lead to reduced investment in accessing clean water resources. Nutrients which are recaptured can be utilized in agriculture, leading to soil improvement, increased food security, and decreased pollution, increasing quality of life. Systems with the top 5 recovery rates include onsite composting and blackwater systems.

A gap exists in practice and data regarding decentralized sustainable sanitation. Additional, improved options need to be developed. This study explores ecological or nature-based sanitation concepts which could help mitigate the current crises of water shortages and pollution and provide a more sustainable alternative to septic technology. The goal is to explore technologies which could be combined, are modular, scalable, meet or exceed treatment standards, and reclaim water and nutrients.

### Liquid Composting/Thermophilic Aerobic Digestion

Liquid composting is a biological process of organic matter degradation by bacteria in a liquid medium, in the presence (aerobic) or absence (anaerobic) of oxygen. One type of aerobic wastewater treatment processing is called (Autothermic) Anaerobic Thermophilic Digestion. It occurs in a reactor which is a prefabricated, compact, and self-contained unit suitable for local operation. The substrate is aerated to drive the aerobic reaction, and the reaction process auto-generates heat of up to 70 degrees Celsius, which sterilizes the contents. The number of bacteria present in the end product is below international standard for microbes in water intended for reuse and can be used as a liquid fertilizer. The reactor creates no pollution and loses less than 1% ammonia When liquid composting/TAD is conducted successfully, a very high percentage of the nutrients are recaptured or retained and the substrate is utilized rather than being treated as a waste product.

Domestic blackwater and food waste has been successfully processed in a local ATAD reactor and used the end product as a liquid fertilizer, creating a localized closed system. A different type of aerobic treatment unit (AWT) for onsite residential use exists and is used in areas where septic tanks are not appropriate. However, an additional disinfection step is needed, the effluent is still treated as a waste product, and significant energy and maintenance are required (EPA, 2002).

### Rotating Biological Contactor:

Another effective biological treatment is the rotating biological contactor (RBC). The reactor is composed of several horizontal shafts of rotating discs with lattice-structured medium submerged in effluent in an enclosed tank. Rotating the structures alternately exposes the biofilm-occupied medium to the wastewater and to air, to encourage aerobic degradation of organic matter. Rotation creates a mechanical mixing action, keeping organic matter in suspension, and allowing sloughing of excess biofilm mass. The relevant benefits of RBC technology include low energy cost, easy operation, high process stability, small footprint requirement, and high specific removal rate. Commercialized compact models for residential use exist, but are designed to be used underground with discharge to soil or water bodies, with the associated pollution risks.

### Biochar

Biochar from any source is an excellent filtration medium for onsite wastewater treatment and could replace sand, which is becoming depleted. When saturated with nutrients, biochar is useful as a soil amendment, boosting both nutrient and water storage and availability. Like other biological wastewater treatment methods, processing occurs in a biofilm which develops on the large surface area. Studies using biochar for wastewater treatment have found excellent reduction of organic matter (COD), total nitrogen, phosphorous, and E. coli. Biochar can remove heavy metals and organic contaminants such as dyes, in addition to pathogenic bacteria. Biochar can also sequester carbon and remove ammonium nitrogen.

### UV Disinfection

Ultraviolet radiation is effective in removing even chemical-resistant bacteria and involves no chemical residue or by-products (USEPA, 2003). The treatment apparatus is calibrated for wastewater conditions to ensure the correct intensity, exposure time, and configuration (USEPA, 2003).

The efficacy of UV disinfection of greywater recycled for toilet flushing in a housing complex has been studied. Prior to UV exposure, the greywater was treated either with a Rotating Biological Contactor (RBC) plus sedimentation or aeration basin then Membrane Bioreactor (MBR). Both methods resulted in effluent with parameters for which UV disinfection is appropriate. The result of the UV disinfection was a level of fecal coliforms of <10 cfu/100 ml−1 and Salmonella spp. were undetected.

### Methods and Materials

The purpose of this example is to determine whether a novel prototype could be reasonably predicted to achieve a conglomerated water reuse standard for the treatment of blackwater and enable recycling of the treated water for toilet flushing. Existing methods and technologies are explored which could function as a direct substitution, for retrofit, and as scalable options for new construction, to decentralize and improve upon current wastewater treatment.

Two concepts were evaluated based on sustainability criteria and water reuse standards. The design criteria are as follows:
Source separation at household level of blackwater from all other household wastewater
Water and nutrient reclamation
Achieving or exceeding current treatment standards for toilet water reuse
Aboveground and modular for easier maintenance or repair
Easy adoptability and acceptance
Easy integration with current flush-based systems
Potential for scaling and/or adaptation for developing nations or urbanized areas

The combinations examined were thermophilic aerobic digestion (TAD) and rotating biological contactor (RBC); both followed by biochar (BC) filtration and UV sterilization (UV).

The studies of efficacy per treatment method (Table 1) were chosen for their specific focus on blackwater, mixed household wastewater, or sewage sludge, and not greywater, stormwater, separated urine or feces, or animal manure slurries. The most common and comparable parameters were recorded where available: TSS, Tot-N, Tot-P, pH, BOD, COD, Total coliform, E. coli, salmonella, and viruses. The core parameters measured through most of the available studies are TSS, Tot-N, Tot-P, BOD or COD, Total coliform, and E. coli.

Data regarding international drinking water and water reuse parameters were collected and integrated. Drinking water and water reuse standards were compared between International Organization for Standardization (ISO) and the US Environmental Protection Agency regulations. Many standards were equal for both categories, and for any which were different, the more stringent standard was chosen. If a parameter had only one reported standard, that standard was selected. The lowest listed values were taken from each parameter to form a new standard of the most stringent levels. Log 10 reductions were converted to percentage reductions for continuity.

The techniques were evaluated either per their efficiency in reducing or maintaining parameters according to the goal in that treatment step. For example, thermophilic aerobic digestion retains and solubilizes nutrients, so removal of nitrogen or phosphorous is not desired. Subsequent filtration, for example, is meant sequester nutrients from solution for use as a soil amendment. Therefore, both removal and retention are significant. Ultraviolet sterilization was evaluated only on its antimicrobial or microbial inactivation effect, though some degradation of chemical compounds also occurs (USEPA, 2003).

Reported efficacy recorded in academic literature was compared to the new combined international water reuse regulations. An averaged value of reported concentrations of pollutants in blackwater was used as starting values. The data collected was then used to predict potential results from the novel layering of chosen treatment methods in each proposed assembly.

### Results and Discussion

Not all methods had data for every parameter. None of the technologies achieved all of the water quality standards alone. Table 1 shows treatment efficacy per method.

TABLE 1
Removal/uptake efficiency of wastewater
treatment methods studied

| | % Removal | | | | |
|---|---|---|---|---|---|
| | | TOT- | TOT- | | |
| | TSS | N | P | BOD | E. Coli |
| Biochar | 82 | 61 | 89.3 | 82* | 99.65 |
| Thermophilic aerobic digestion | 30 | X | X | 88.4 | 99.999 |
| Rotating biological contactor | 89.3 | 74.2 | 15 | 85 | 97 |
| UV sterilization | X | X | X | X | 99.99 |

X = no data available/not relevant;
*=activated carbon biochar

TABLE 2
Combined technologies post-treatment pollutant levels
and combined water reuse + drinking water standards

| | | | Phos- | | |
|---|---|---|---|---|---|
| | TSS | Nitrogen | phorous | BOD | E. Coli |
| | mg/L | mg/L | mg/L | mg/L | cfu/L |
| Standards-toilet | 30 | X | X | 10 | 1 |
| Standards - drinking water | 4.9 | 10 | 2.4 | 5 | 0 |
| TAD + BC + UV | 27.5 | X | X | 28.6 | 0 |
| RBC + BC + UV | 4.2 | 6.8 | 1.1 | 36.97 | 99.5 |

X = no data available/not relevant

Table 2 describes the results of the predicted efficacy of the proposed treatment trains. Combining TAD with biochar filtration and UV sterilization achieved the combined standard for toilet flushing for TSS and E. coli. RBC treatment followed by BC and UV achieved water reuse standards for TSS, N, and P. Only the TAD reached both standards for E. coli. All technologies performed well in bacterial reduction-above 97%. As UV sterilization can be calibrated per conditions, remaining bacteria are assumed to be eliminated at that step.

The treatment processes with the best percentage of removal or retention of TSS were the RBC and biochar, each as a standalone process. When combined, RBC followed by biochar and UV had the best removal rate. None of the technologies studied achieved 100% nutrient recovery rates, though in theory TAD would allow that if there is no methane escape. The RBC had the highest percentage of N removal (uptake) from effluent at nearly 75%. Because RBC and TAD technology involve aerobic digestion, little or no nitrogen is lost via methane or ammonia. The combined technologies achieved better than drinking water standards for TSS, N and P levels.

There is a lack of data regarding the use of these technologies in this scaled-down context, and the review is not exhaustive. Prototype testing is necessary to determine suitability. Design questions would have to be answered such as volume parameters, flow and retention, and safety measures. The next steps toward further evaluating these concepts include feasibility, cost, and life cycle analysis. Future research would need to focus on the efficiency of scaled down models, as existing prototypes are either small lab-based experiments or large processing facilities.

### DISCUSSION

Each of the primary biological treatment methods discussed have proven efficacy in achieving treatment standards or near enough to indicate feasibility. The analysis of the proposed assemblies showed promise in enabling onsite recycling of blackwater to toilet water flushing while reclaiming nutrients. The methods reviewed here could be retrofitted to existing dwellings, maintaining flush technology. They would not force a user habit change, increasing the chance of acceptance.

One of the major advantages of the concepts explored includes water recycling, where nearly 30% of a household's total water usage could be eliminated by near-perpetual recycling through these proposed systems. They create a nearly closed, resource-efficient system vs. end of pipe technologies.

Energy is used to power these technologies; however, nutrients can be reclaimed as well as water and energy in the form of heat. Bringing the assembly above ground could also bring it into more awareness as a reminder of resource use and any needed maintenance. There could be an increased level of maintenance required compared to septic. Septic system maintenance is often neglected, possibly due to being obscured underground.

Eliminating a drain field would reduce the footprint, deforestation, and soil disturbance. These concepts would have greater resilience regarding availability of water resources, site challenges, and extreme weather. These designs are very flexible and can be tailored to many different situations. They are not necessarily more mechanically complex than any typical household appliance. This is important to ensure usability, acceptance, and accessibility for property owners.

### Thermophilic Aerobic Digestion

TAD is a somewhat flexible treatment method as the feed mixture can contain as little as 2.2% organic matter in order to sustain the microbiological digestion process. Regular (not low-flush) toilet effluent can be used, encouraging user acceptance. The overall level of incidental pollution or waste is extremely low, and nutrient capture is high. Heat produced during the reaction cycle could be captured. Challenges include use of a consistent supply energy and possible technological or equipment malfunctions.

### Rotating Biological Contactor

Data regarding the RBC shows the best performance across all parameters of the methods studied. The mechanism of a rotating biological contactors is relatively simple, and the process is biological (facultative, mostly aerobic). The main processing mechanism is housed in an enclosed structure for protection, which enables aboveground placement and accessibility.

The rotation of the discs allows aeration and shearing away of any excess biofilm mass. Completely submerged reactors are more effective; however, this use would require mechanical aeration.

There is some power usage, so backup power would need to be provided to ensure continuous operation. If there were an interruption in the biological process, it could take time to re-establish a functional amount of biofilm. Heat does not appear to be a byproduct of this process, and therefore not recoverable. As biological processes are temperature-dependent, management of influent temperature may be required.

### Biochar

The inclusion of biochar prior to UV sterilization is an advantage due to its enhanced removal of suspended solids, which interfere with UV effectiveness. When pre-enriched with nutrients and used as a soil amendment, biochar eliminates the need for chemical fertilizers, increases crop yields, increases water retention, and decreases greenhouse gas emissions. Use as a soil amendment would decrease eutrophication due to the washout of nutrients following irrigation. If intended for use as soil amendment and local markets are already saturated, re-pyrolization may be the best option.

### UV Radiation

UV sterilization is a very effective method of sterilization which requires energy input but little space. Its intensity and effect can (and should be) adjusted to contents and volume of effluent. It is effective against bacteria, viruses, spores, and come cysts. It also can degrade some pollutants such as steroid hormones and pharmaceuticals (USEPA, 2003).

The effectiveness of UV sterilization is a constant, i.e., the concentration of microorganisms prior to treatment is proportionate to the concentration after. The intensity and duration must be correctly matched to the influent composition. As there is no chemical treatment involved, reinfection downstream is not prevented. It may be advisable to reserve the UV treatment component for application directly prior to use. This could create a design problem to ensure there is a sufficient duration of time for the UV exposure to work, though this could be achieved in as little as 6 seconds. As with the other methods, a power supply must be constant.

### CONCLUSION

Given the array of benefits of various methods of ecological sanitation, and our swift movement towards global ecological crises, action must be taken nationally and internationally. Issues around water and sanitation cross boundaries in every sense: governmental, regulatory, scientific, professional, agricultural, health-related, and geographical. Water and sanitation cannot continue to be ignored.

In order to achieve any measure of sustainability or water resilience, ecological sanitation methods should be incorporated into onsite wastewater management practices. Each technology considered in this study already has proven efficacy in a similar or larger-scale context. The study proposes a novel approach (to the author's knowledge) and highlighting the potential of other possible ecological sanitation design options. The design complexity is roughly equivalent to any modern household appliance.

Prototypes such as RBC or TAD processing followed by biochar filtration and UV sterilization could contribute significantly to sanitation, water and nutrient resiliency, and food security. They could increase climate change resiliency by decreasing pollution and greenhouse gas emissions and increasing carbon sequestration. Stress could be decreased on infrastructure, energy, and freshwater resources. Embracing sustainable sanitation technology can be a significant step forward in global development goals and climate change resilience.

### Example 2

### Biological Process Augmentation:

Issues related to inefficient thermophilic aerobic digestion or aerobic liquid composting due to lack of nutrient density or other biological conditions could be resolved by the addition of thermophilic bacteria, enzymes, and/or chemical or mineral additives in addition to efficient mechanical aeration. Thermal augmentation is also possible but passive vs mechanical augmentation is preferrable in principle. Retention time for bioprocessing can vary according to speed and efficiency of biological reaction, which can be affected by bacterial, enzymatic, or chemical augmentation (or none), volume and dilution of blackwater, and rate of system input, i.e., batch, semi-batch, or continuous flow processing, all of which could be interdependent variables. In addition, one or two stages could be used according to above variables, stability of mechanical and/or electrical systems, and energy efficiency.

### Early-Mid Process Filtration/Amelioration of Emissions/Recapturing Biological Byproducts:

Composting or digestion of biological materials can produce undesired emissions. ATAD used for sewage sludge processes can generate pollutants such as ammonia (liquid or gaseous), methyl sulfides, and volatile organic compounds, among others. Biofiltration of emissions in conjunction with ATAD has been studied using, for example, a peat filter. However, peat is not a sustainable material. Algae biofiltration can remove 78-99% of CO₂ and >95% ammonia, as gaseous fraction or liquid/solubilized. Excess algal biomass could be (vermi) composted to capture nutrients and close the waste loop.

### Vermicomposting (Vermifiltration, Lumbrifiltration):

Vermicomposting or vermifiltration has been successfully demonstrated as a treatment process for food waste as well as household and agricultural wastewater. Benefits include the bioprocessing of chemicals as well as creating a self-renewing soil amendment. The drawbacks include potential death of the bio processors (worms), though under extreme conditions, and the need for periodic removal.

### Upstream Variations:

Vacuum, foam, micro or low-water flush systems can decrease the initial amount of water needed and augment the digestion process of (A) TAD. Incorporating food waste further increases biological substrate availability for un-augmented autothermal thermophilic aerobic digestion. Alternatively, if the moisture content is low enough, aerobic composting could occur in a rotating drum rather than a liquid-based vessel assembly.

### Aeration:

Solubilization of oxygen at higher temperatures decreases. The minimum concentration of oxygen needed for thermophilic digestion is 1 ppm, which occurs at just over 60 degrees C. Various options for aeration are possible, mechanical via a pump or concentrator, or by physical turning.

### ADDITIONAL INFORMATION

### Sizing:

The USEPA (n.d.) estimates that ‘average’ American families use 50 gallons of water per day for toilet flushing, or around 18.5 gallons (70 liters) per person, per day (USEPA, 2002). Europeans use an average of 120 liters per day, and around 30% of that is estimated to be used on toilet flushing, which gives an average of 40 liters (10.5 gallons) per person, per day. Various sources estimate food waste at around a pound per day for Americans, and close to the same for Europeans. Food waste volume varies per weight according to source. Human waste volume averages 1.6 liters (almost a half gallon) per person per day. Therefore, treatment systems should be able to accommodate a maximum of 75 liters of volume of combined waste per person per day for American households, and 45 liters per person per day in European households if food waste is included.

Applications:

| | |
|---|---|
| Residential | Environmentally sensitive areas |
| Commercial | Non-sewered areas |
| Multi-Family | Retrofitting of existing buildings |
| Schools | Drought-prone areas |
| Hospitals | Flood-prone areas |
| Residential Facilities | Remote areas |

### Final Filtration/Sterilization:

Final sterilization immediately prior to flushing could occur by UV radiation or by filtration through various means such as reverse osmosis, nanofiltration, or ultrafiltration (Fujioka et al., 2019, Pal, 2017).

### Removal Efficiencies

| | Percent Removal | | | | | | | | |
|---|---|---|---|---|---|---|---|---|---|
| | | | | | | | | Total | |
| | | | NH₄-N | | | | | Coliform | |
| | | | Ammonium | | | | | or (log10 | E. |
| | TSS | Tot-N | Nitrogen | Tot-P | pH | BOD | COD | reduction) | Coli |
| Floating treatment | 78 | 51.1 | | 43.2 | | 68.2 | 58.3 | | 99.4 |
| wetland | | | | | | | | | |
| Biochar | 82 | 61 | 70 | 89.3 | | | 94.5 | | 99.65 |
| Autothermic thermophilic | 80 | | | | | | 55 | <10 cfu | <10 cfu |
| aerobic digestion | | | | | | | | remaining | remaining |
| Rotating biological | 89.3 | 74.2 | 74.8 | 15 | | 85 | 89.7 | | 97 |
| contactor | | | | | | | | | |
| Vermicomposting/ | 82.1 | | 76.5 | 92.5 | 7 | 86.7 | 82.2 | 88 | 99.3 |
| Vermifiltration | | | | | | | | | |
| UV sterilization | | | | | | | | | 99.9 |

Although the description of the operation of the various systems and corresponding figures show a specific order of components, it is understood that the order of components can differ from that which is depicted. Additionally, although the figures show a specific order of execution, it is understood that the order of execution can differ from that which is depicted. For example, the order of two or more components can be scrambled relative to the order shown. Also, two or more components or blocks shown in succession can be executed concurrently or with partial concurrence. Further, in some embodiments, one or more of the components shown in the figures can be skipped or omitted. It is understood that all such variations are within the scope of the present disclosure.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a macerating pump having a solid waste input, the macerating pump configured to convert the solid waste input into a slurry;
a holding tank in fluidic communication with the macerating pump, the holding tank configured to store the slurry;
a bioreactor in fluidic communication with the holding tank, the bioreactor configured to biochemically break down the slurry into a gas output and a liquid substrate;
a biochar filter in fluidic communication with the bioreactor, the biochar filter configured to absorb nutrients from the liquid substrate to produce a treated liquid substrate; and
a sterilization unit in fluidic communication with the biochar filter, the sterilization unit configured to remove a plurality of pollutants from the treated liquid substrate.

2. The system of claim 1, wherein the bioreactor comprises a vermicomposting vessel having a substrate configured to enable drainage of a leachate from the liquid substrate, the leachate being directed to the biochar filter.

3. The system of claim 1, wherein the bioreactor comprises a rotating biological contactor configured to remove pollutants from the slurry and separate the gas out from the liquid substrate.

4. The system of claim 1, wherein the bioreactor comprises an aerobic digester configured to digest the slurry and capture an amount of heat released from digestion.

5. The system of claim 1, further comprising an algae biofilter in fluidic communication between the bioreactor and the biochar filter, the algae biofilter configured to diffuse the gas output of the bioreactor into the liquid substrate and further configured to absorb nutrients from the liquid substrate.

6. The system of claim 1, further comprising a second holding tank disposed between, and in fluidic communication with, the biochar filter and the sterilization unit, the second holding tank configured to regulate fluid flow between the biochar filter and the sterilization unit.

7. The system of claim 1, wherein the sterilization unit comprises at least one of an ultraviolet water sterilizer, a microfiltration membrane, or ultrafiltration membrane.

8. The system claim 1, wherein the solid waste input is residential blackwater.

9. The system claim 1, wherein the solid waste input is food waste.

10. The system of claim 1, wherein the solid waste input is a combination of residential blackwater and food waste.

11. A method, comprising:
macerating a solid waste input by a macerating pump to produce a slurry;
reacting the slurry in a bioreactor to produce a gas output and a liquid substrate;
absorbing nutrients from the liquid substrate using a biochar filter to produce a treated liquid substrate; and
sterilizing the treated liquid substrate from the biochar filter to produce an amount of sterilized water.

12. The method of claim 11, further comprising receiving the solid waste input from at least one toilet.

13. The method of claim 12, further comprising returning the amount of sterilized water to the at least one toilet.

14. The method of claim 11, further comprising regulating a flow rate of the slurry through an outlet of a holding tank into the bioreactor.

15. The method of claim 11, wherein reacting the slurry in a bioreactor further comprises:
vermicomposting the slurry; and
draining a leachate from the bioreactor.

16. The method of claim 11, wherein reacting the slurry in a bioreactor further comprises using a rotating biological contactor to remove pollutants from the slurry and separate the gas out from the liquid substrate.

17. The method of claim 11, wherein reacting the slurry in a bioreactor further comprises:
digesting the slurry in an aerobic digester; and
capturing an amount of heat released from digestion.

18. A system, comprising:
a grinder having a solid waste input, the grinder configured to convert the solid waste input into a slurry;
a bioreactor in fluidic communication with the grinder, the bioreactor configured to break down the slurry into a gas output and a liquid substrate;
a filter in fluidic communication with the bioreactor, the filter configured to produce a treated liquid substrate; and
a sterilization unit in fluidic communication with the filter, the sterilization unit configured to remove a plurality of pollutants from the treated liquid substrate.

19. The system of claim 18 further comprising a holding tank in fluidic communication with the grinder and the bioreactor, the holding tank configured to store the slurry.

20. The system of claim 18, wherein the filter is a biochar filter.

21-30. (canceled)
